(19) United States
(12) Patent Application Publication
(10) Pub. No.: US 2014/0278650 A1
(43) Pub. Date: Sep. 18, 2014

(54) MOBILE COLLABORATIVE WORKFORCE SCHEDULING

(71) Applicants: Ramin Bagheri, Los Altos, CA (US); Kouros Behzad, Redwood City, CA (US)

(72) Inventors: Ramin Bagheri, Los Altos, CA (US); Kouros Behzad, Redwood City, CA (US)

(73) Assignee: SAP AG, Walldorf (DE)

(21) Appl. No.: 13/826,080

(22) Filed: Mar. 14, 2013

(51) Int. Cl. G06Q 10/06

(52) U.S. Cl. CPC G06Q 10/063116
USPC 705/7.16

(57) ABSTRACT

Generally discussed herein are systems, apparatuses, and software for mobile collaborative workforce scheduling. An apparatus can include at least one processor and a storage device, a work schedule saved to the storage device, a communications module operable to communicate the work schedule to a plurality of mobile devices and receive a request to change the work schedule from the mobile devices, and a user interface module to execute on the processor and to provide authorized personnel access to operations performed by the at least one processor, the operations including approving and denying the request to change the work schedule.

### BACKGROUND INFORMATION

The modern workforce is increasingly connected using cellular or internet based communication devices. Scheduling a workforce can be complex. This is especially true in industries that have many different employees scheduled to perform the same task. These employees can ask to have their scheduled changed or to swap shifts with another employee. An employee supervisor can be required to review, analyse, and approve or deny these schedule changes, creating work for the supervisor. In some cases, an employee simply cannot make it to work to fulfil their shift or accomplish their tasks. This employee may not know that they cannot make it to the shift until shortly before the shift, thus making it difficult to find a replacement.

### BRIEF DESCRIPTION OF THE DRAWINGS

FIG. 1 illustrates a diagram of an example of a system configured for mobile collaborative workforce scheduling.

FIG. 2 illustrates a block diagram of an example of a user interface of a mobile collaborative workforce scheduling application.

FIG. 3 illustrates another block diagram of an example of a user interface for a mobile collaborative workforce scheduling application.

FIG. 4 illustrates a flow diagram of an example of a technique for mobile collaborative workforce scheduling.

FIG. 5 illustrates an example of a computing device.

### DETAILED DESCRIPTION

Various embodiments herein include at least one of systems, methods, and software to help schedule and track a mobile collaborative workforce. One or more embodiments can include an apparatus including at least one processor and a storage device, a work schedule saved to the storage device, a communications module operable to communicate the work schedule to a plurality of mobile devices and receive a request to change the work schedule from the mobile devices, and a user interface module to execute on the processor and to provide authorized personnel access to operations performed by the at least one processor, the operations including approving and denying the request to change the work schedule.

Modern technology (e.g., a smartphone, laptop, tablet, personal digital assistant (PDA), or the like) can include features that allow a workforce to stay more closely connected than in the past. The features of this modern technology can be exploited or leveraged to broadcast a proposed change in a schedule (e.g., in real-time) to relevant employees or managers. The features can also be exploited to provide reports directly to the employee. Such a configuration can provide a system that provides workforce schedules in real time to employees or other users. The system can also be collaborative and help reduce the risk of a resource shortage in executing on scheduled tasks due to late-notice absences.

Many people and businesses communicate using mobile devices coupled to the internet or a cellular network. A problem associated with workforce scheduling includes rescheduling and tracking changes to the defined schedule. For example, it can be difficult to find a replacement for a worker who cannot accomplish a task or duty they were assigned to accomplish. By extending scheduling or task management to a mobile device platform (e.g., a platform including a personal digital assistant (PDA), smart phone, tablet, laptop, or the like) one or more portions of the scheduling or task management can be streamlined or automated.

In one or more embodiments, an authorized entity (e.g., a manager, supervisor, employee, or the like) can communicate (e.g., broadcast, unicast, or multicast) one or more tasks to be accomplished to one or more personnel of the business. The authorized entity can communicate one or more tasks to be accomplished on behalf of another. For example, in a grocery store where a cashier has an emergency and finds out twenty minutes before his or her shift that they cannot make it to work, the supervisor can send a request on behalf of the cashier asking for a replacement cashier. The cashier could alternatively ask other personnel authorized to submit the request for a replacement.

Those receiving the communication can respond as to whether they are available to help accomplish the task. In addition, the system can allow those who wish to take on more tasks to communicate to other personnel that they are able to help with another task. Another member can then delegate his or her responsibilities to the personnel seeking more work. This can be done with little or no supervisor, manager, or other user involvement. In one or more embodiments, the supervisor or manager can be prompted to verify that the delegating or swapping of tasks is proper before the schedule reflects the change. If the task delegation or swap is approved or denied, a message can be sent to the parties interested in delegating or swapping indicating that change is or is not approved, respectively.

An advantage of such systems, methods, and software can include having real-time visibility of who is or is not scheduled, including pending requests to change the schedule. Another advantage can include reducing the amount of time it takes to communicate openings with workers or to fill tasks (e.g., work shifts) so the business runs smoother. Another advantage can include filling work shift or task openings in a short amount of time, such as through crowdsourcing (e.g., obtaining replacements by soliciting a group of personnel to find a replacement).

One or more embodiments that can include one or more of the advantages discussed are described in detail below with reference to the drawings.

FIG. 1 shows an example of a system 100 configured for automatic workforce scheduling. The system 100 can include a terminal 102 (e.g., a master terminal) in communication with a plurality of devices 104A, 104B, 104C, 104D, and 104E.

The terminal 102 can be a computing device, such as a server, PDA, mobile device, or other computing device, that includes a user interface module 106 or a database 108 (e.g., a memory). The user interface module 106 can provide a user access to functionality provided by an application 107 stored on the terminal 102, such as through a user interface. The application 107 can be configured for automated workforce scheduling. The application 107 includes code that can be translated to instructions and executed by a processor to provide the functionality to the user.

The application 107 can be hosted by the terminal 102 or can be hosted remotely, such as on a remote server, on one or more of the devices 104A-104E, or in the cloud (e.g., over the Internet). Terminal 102 can include a communications module 109 to communicate with the devices 104A-104E via a network connection. Each device 104A-104E can include an instantiation of the application 107 stored and running thereon. Each device 104A-104E can include memory that stores data substantially similar to the data stored by the database 108.

The functionality provided through the application 107 can include providing the ability to view, alter, or save a workforce schedule. The application 107 can be coupled to circuitry operable to communicate (e.g., broadcast, multicast, or unicast) the workforce schedule to the devices 104A-104E or receive a request to change the workforce schedule from one of the devices 104A-104E. Through such coupling, the application 107 can provide a user the ability to communicate the workforce schedule or the request to change the workforce schedule, such as to the devices 104A-104E. In one or more embodiments, the application 107 can allow personnel to request a change to the workforce schedule directly through the user interface module 106. Each of the devices 104A-104E can include a user interface similar to the user interface provided by the user interface module 106.

The application 107 can allow personnel to authorize or deny a change to the workforce schedule. In one or more embodiments, the application 107 can verify that a user is authorized to accept or deny the change to the workforce schedule before the user is allowed to accept or deny the request to change the workforce schedule. Verifying that a user is authorized to accept or deny the change can include prompting the user for user identification (ID) or password, doing a biometric scan, a combination thereof, or other method of verifying a user is authorized to accept the change.

The application 107 can update (e.g., automatically) the workforce schedule in response to personnel accepting the request. The request to change the workforce schedule can include requesting to give up work or take on more work (e.g., a shift or task). The application 107 can, though the communications module 109, send a message to mobile devices related to the request in response to the personnel approving or denying the request. Personnel related to the request can include the personnel requesting the change to the work schedule, the personnel interested in accommodating the change to the work schedule (e.g., the person taking on more work or the person giving up work depending on whether the request to change the workforce schedule is a request to give up work or take on more work, respectively), the supervisor(s) of those personnel, or others directly or indirectly affected by the change in the workforce schedule.

The application 107 can provide the ability to communicate an updated schedule to the mobile devices 104A-104E in response to a change in the workforce schedule, such as through communications module 109.

One or more of the functions or abilities provided by the application 107 can be provided automatically (e.g., without human intervention). For example, in response to a request to change the workforce schedule being accepted, the application 107 can alter the workforce schedule to reflect the proper changes without any human intervention. Similarly, the messages to the related personnel can be sent in response to the request to change the workforce schedule being accepted or rejected automatically without human intervention. In addition, the updated workforce schedule can be automatically communicated to the mobile devices 104A-104E automatically without human intervention. Further, the application 107 can automatically determine if the personnel willing to accommodate the requested change in the workforce schedule is qualified to accommodate the change (e.g., has the proper skills required to accommodate the request). Further yet, the application 107 can automatically broadcast to the mobile devices 104A-104E a message or alert indicating a request to change the workforce schedule is pending (with or without verifying that the personnel willing to accommodate the request is qualified to do so).

The master terminal 102 can include a database 108. The database 108 can be hosted locally (as shown in FIG. 1) or can be hosted remotely, such as through a network or the Internet. The database 108 can include data about personnel on a workforce. The data about the personnel can include data identifying the times and dates the personnel are scheduled to work, the tasks the personnel are qualified to do, a maximum or minimum number of hours the personnel are required to work in a given time period (e.g., week, month, etc.), preferences the personnel have for certain tasks or shifts, personnel restrictions or preferences on times or dates that the personnel are or are not available to work, among other data.

FIG. 2 shows an example of a user interface 106A for automating workforce scheduling. The user interface 106A can display the current schedule 200, and can include one or more buttons, which when activated, can provide functionality of the application 107 to the user. The user interface 106A shows a schedule 200 that was created using a shift-based workforce-scheduling scheme.

The buttons can include a request replacement button 210, a request shift button 212, an approve button 214, a deny button 216, or a send schedule button 218. In response to a user activating the request replacement button 210, the application 107 can cause a pop-up window or another screen that prompts the user to enter information to be shown. The prompt can include a request for the date and time of the shift, or duties required to be accomplished during the shift. The prompt can include a request for the requesters identity (e.g., an ID associated with the requester, the name of the requester, or some other identifier of the requester which may or may not be unique the requester). In one or more embodiments, the application 107 can pre-fill information in the prompt, such as with the requester's identity if the user provided their ID in using the application 107, the duties assigned to be accomplished during the shift, or other information that can be deduced by the application 107.

In response to a user activating the request shift button 212, the application 107 can cause a pop-up window or another screen that prompts a user for information to be shown. The prompt can include a request for the date(s) and time(s) the requester is willing to work, the identity of the requester, the duties the requester is qualified to take on, or the duties the requester is looking to take on. In one or more embodiments, the application 107 can pre-fill information in the prompt, such as with the duties the user is qualified to take on.

In response to a user activating the approve button 214, the application 107 can cause a display to show a pop-up window or another screen that prompts a user for information. The prompt can include a prompt for an ID associated with the user. Such a prompt can help ensure that only authorized personnel accept changes to the workforce schedule 200. In response to a valid authorized user activating the approve button 214, the workforce schedule 200 can be updated to reflect the change. The application 107 can respond by causing a prompt for an ID associated with the user to be displayed when a user activates the deny button 216. Requiring a user to verify their identity through the entry of an ID can help ensure that only authorized personnel are denying changes to the workforce schedule 200.

In response to a user activating the send schedule button 218, the applicant can cause a display to show a pop-up window or another screen that prompts a user for an ID. The application 107 can send the schedule 200 to the devices 104A-104E in response to the user activating the send schedule button 218 (with or without verifying the identity of the user who activated the send schedule button 218).

FIG. 3 shows an example of a user interface 106B for automating workforce scheduling. The user interface 106B can display the current workforce schedule 200B, and can include one or more buttons, which when activated, can provide functionality of the application 107. The user interface 106B shows a schedule 200B that was created using a task-based workforce-scheduling scheme. Such a scheme can include a request task button 320. The request task button 320 can be substantially similar to the request shift button 212, with the request task button 320 causing a prompt to be displayed prompting a user to provide the task(s) they wish to take on in response to a user activating the request task button 320.

FIG. 4 shows an example of a technique 400 for mobile collaborative workforce scheduling. At 402, a workforce schedule (e.g., schedule 200A or 200B) can be sent to a plurality of devices 104A-104E. At 404, a request to change the workforce schedule can be received. The request to change the workforce schedule can be communicated (e.g., automatically) to the plurality of mobile devices 104A-104E. Under some circumstances, the application 107 can determine (e.g., automatically) which personnel are qualified to take on the work associated with the request to change the workforce schedule and can communicate the request to change the workforce schedule to those personnel qualified to take on the work. In other circumstances, the application 107 does not discriminate and sends the request to all the devices 104A-104E regardless of the qualifications of the personnel associated with the device 104A-104E.

At 406, data indicating if the request to change the workforce schedule is accepted can be received. An identity of the user accepting the schedule change can be verified, such as by prompting the user for an ID and verifying that the ID entered is associated with permissions sufficient to accept or reject a request to change the workforce schedule. In one or more embodiments, the database 108 includes data indicating which IDs are authorized to accept or deny the request to change the workforce schedule (e.g., permissions). Data from a device 104A can be received, such as at the terminal 102 or communications module 109, indicating that an entity on the workforce is willing to accommodate the schedule change. The application 107 can determine (e.g., automatically) if the entity willing to accommodate the schedule change is qualified to accommodate the schedule change. Determining if the entity is qualified can be accomplished by verifying, such as by using the application 107, that data in the database 108 indicates that the personnel associated with an ID is qualified to accommodate the schedule change (e.g., by verifying the permissions of the personnel).

In one or more embodiments, authorized personnel are not required to accept or deny a request before the schedule change is approved or denied. The approval or denial can be granted automatically using permissions and other data associated with an ID of a user, such as can be stored in database 108. In such embodiments, a message can be automatically sent to the personnel willing to accommodate the schedule change, personnel requesting the schedule change indicating, or other personnel that the request to change the schedule was accepted or approved. In one or more embodiments, a request can be sent and the application or authorized personnel can wait for a specified period of time before approving or denying the request. In this way multiple entities can show an interest in accommodating the request. The authorized personnel or the application can decide who will be allowed to accommodate the request by applying a heuristic. Some example heuristics include “first come, first served”, seniority, number of hours the entity willing to accommodate is required to work, among others.

At 408, the workforce schedule can be updated (e.g., automatically) in response to accepting the workforce schedule change. At 410, the updated workforce schedule can be communicated (e.g., automatically) to the plurality of devices 104A-104E.

FIG. 5 is a block diagram of a computing device, such as one or more of devices 104A-104E, according to an example embodiment. In one or more embodiments, multiple such computer systems are utilized in a distributed network to implement multiple components in a transaction-based environment. An object-oriented, service-oriented, or other architecture can be used to implement such functions and communicate between the multiple systems and components. An example computing device in the form of a computer 510 can include a processing unit 502, memory 504, removable storage 512, and non-removable storage 514. Memory 504 can include volatile memory 506 and non-volatile memory 508. Computer 510 can include—or have access to a computing environment that includes—a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 can include or have access to a computing environment that includes input 516, output 518, and a communication connection 520 that may include a communications module 109 to communicate with mobile devices via a port coupled to a network connection such as the internet or cellular network. The computer can operate in a networked environment using a communication connection to connect to one or more remote computers, such as database servers. The remote computer can include a personal computer (PC), server, router, network PC, a peer device or other common network node, or the like. The communication connection can include a Local Area Network (LAN), a Wide Area Network (WAN) or other networks. Computer-readable instructions stored on a computer-readable medium are executable by the processing unit 502 of the computer 510. A hard drive, CD-ROM, and RAM are some examples of articles including a non-transitory computer-readable medium. For example, a computer program 525 capable of performing one or more of the methods illustrated and described herein can be stored on a non-transitory computer-readable medium. An example of such a computer program can include a computer readable storage device including instructions stored thereon, the instructions, which when executed by a machine, cause the machine to perform operations including sending a work schedule to a plurality of mobile devices, receiving a request to change the work schedule, receiving data indicating if the request to change the work schedule is accepted, updating the schedule via a programmed processor in response to accepting the work schedule change, and broadcasting the updated work schedule via a communications module to the plurality of mobile devices.

### Additional Notes and Examples

In Example 1 an apparatus includes at least one processor and a storage device, and a work schedule saved to the storage device.

In Example 2, the apparatus of Example 1 includes a communications module operable to communicate the work schedule to a plurality of mobile devices and receive a request to change the work schedule from the mobile devices.

In Example 3, the apparatus of at least one of Examples 1-2 includes a user interface module to execute on the processor to provide authorized personnel access to operations performed by the at least one processor, the operations including approving and denying the request to change the work schedule.

In Example 4, the communications module of at least one of Examples 1-3 is operable to broadcast the work schedule to the plurality of mobile devices.

In Example 5, the request to change the work schedule of at least one of Examples 1-4 is a request to give up work.

In Example 6, the request to change the work schedule of at least one of Examples 1-5 is a request from an entity associated with a mobile device of the plurality of mobile devices to take on more work.

In Example 7, the at least one processor of at least one of Examples 1-6 automatically alters the work schedule as a function of the approval in response to the authorized personnel approving the request.

In Example 8, the communications module of at least one of Examples 1-7 is operable to automatically send a message to mobile devices related to the request in response to the authorized personnel approving or denying the request.

In Example 9, the communications module of at least one of Examples 1-8 is operable to automatically communicate an updated schedule to the mobile devices in response to the work schedule changing.

In Example 10, a method includes sending a work schedule to a plurality of mobile devices.

In Example 11, the method of at least one of Examples 1-10 includes receiving a request to change the work schedule.

In Example 12, the method of at least one of Examples 1-11 includes receiving data indicating if the request to change the work schedule is accepted.

In Example 13, the method of at least one of Examples 1-12 includes updating the schedule via a programmed processor in response to accepting the work schedule change.

In Example 14, the method of at least one of Examples 1-13 includes broadcasting the updated work schedule via a communications module to the plurality of mobile devices.

In Example 15, the method of at least one of Examples 1-14 includes verifying that a user accepting the work schedule change is authorized to accept the work schedule change before updating the work schedule.

In Example 16, the method of at least one of Examples 1-15 includes broadcasting the request to change the work schedule to the plurality of mobile devices.

In Example 17, the method of at least one of Examples 1-16 includes receiving data from a mobile device of the plurality of mobile devices indicating that an entity on the workforce is willing to accommodate the work schedule change.

In Example 18, the method of at least one of Examples 1-17 includes determining if the entity willing to accommodate the work schedule change is qualified to accommodate the work schedule change.

In Example 19, the method of at least one of Examples 1-18 includes sending a message to the entity willing to accommodate the work schedule change in response to automatically determining if the entity willing to accommodate the work schedule change is qualified to accommodate the work schedule change.

In Example 20, receiving a request to change the work schedule of at least one of Examples 1-19 includes receiving a request from a mobile device indicating the user of the mobile device is willing to take on more work.

In Example 21a computer readable storage device including instructions stored thereon, the instructions, which when executed by a machine, cause the machine to perform operations including sending a work schedule to a plurality of mobile devices.

In Example 22 the computer readable storage device of at least one of Examples 1-21 includes instructions, which when executed by a machine, cause the machine to perform operations including receiving a request to change the work schedule.

In Example 23, the computer readable storage device of at least one of Examples 1-22 includes instructions, which when executed by a machine, cause the machine to perform operations including receiving data indicating if the request to change the work schedule is accepted.

In Example 24, the computer readable storage device of at least one of Examples 1-23 includes instructions, which when executed by a machine, cause the machine to perform operations including updating the schedule via a programmed processor in response to accepting the work schedule change.

In Example 25, the computer readable storage device of at least one of Examples 1-24 includes instructions, which when executed by a machine, cause the machine to perform operations including broadcasting the updated work schedule via a communications module to the plurality of mobile devices.

In Example 26, the computer readable storage device of at least one of Examples 1-25 includes instructions, which when executed by a machine, cause the machine to perform operations including verifying that a user accepting the work schedule change is authorized to accept the work schedule change before updating the work schedule.

In Example 26, the computer readable storage device of at least one of Examples 1-25 includes instructions, which when executed by a machine, cause the machine to perform operations including broadcasting the request to change the work schedule to the plurality of mobile devices.

In Example 27, the computer readable storage device of at least one of Examples 1-26 includes instructions, which when executed by a machine, cause the machine to perform operations including receiving data from a mobile device of the plurality of mobile devices indicating that an entity on the workforce is willing to accommodate the work schedule change.

In Example 28, the computer readable storage device of at least one of Examples 1-27 includes instructions, which when executed by a machine, cause the machine to perform operations including determining if the entity willing to accommodate the work schedule change is qualified to accommodate the work schedule change.

In Example 28, the computer readable storage device of at least one of Examples 1-27 includes instructions, which when executed by a machine, cause the machine to perform operations including sending a message to the entity willing to accommodate the work schedule change in response to automatically determining if the entity willing to accommodate the work schedule change is qualified to accommodate the work schedule change.

Some embodiments implement the functions in two or more specific interconnected hardware modules or devices with related control and data signals communicated between and through the modules, or as portions of an application-specific integrated circuit. Thus, the exemplary process flows are applicable to software, firmware, and hardware implementations.

Systems and methods of the present disclosure may be implemented on a mobile device as a mobile application, web-based application, on a desktop computer as a computer application, or a combination thereof. A mobile application may operate on a Smartphone, tablet computer, portable digital assistant (PDA), ruggedized mobile computer, or other mobile device. The mobile device may be connected to the Internet or network via Wi-Fi, Wide Area Network (WAN), cellular connection, WiMax, or any other type of wired or wireless method of networking connection. In some embodiments, a web-based application may be delivered as a software-as-a-service (SaaS) package (e.g. cloud-based embodiments) accessible via a device app, a web browser application, or other suitable application, depending on the particular embodiment.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

It will be readily understood to those skilled in the art that various other changes in the details, material, and arrangements of the parts and method stages which have been described and illustrated in order to explain the nature of the inventive subject matter can be made without departing from the principles and scope of the inventive subject matter as expressed in the subjoined claims.

What is claimed is:

1. An apparatus comprising:
at least one processor and a storage device;
a work schedule saved to the storage device;
a communications module operable to communicate the work schedule to a plurality of mobile devices and receive a request to change the work schedule from the mobile devices; and
a user interface module executable by the at least one processor to provide authorized personnel access to operations performed by the at least one processor, the operations including approving and denying the request to change the work schedule.

2. The apparatus of claim 1, wherein the communications module is operable to broadcast the work schedule to the plurality of mobile devices.

3. The apparatus of claim 1, wherein the request to change the work schedule is a request to give up work.

4. The apparatus of claim 1, wherein the request to change the work schedule is a request corresponding to an entity associated with a mobile device to take on more work.

5. The apparatus of claim 1, wherein the at least one processor automatically alters the work schedule as a function of the approval in response to the authorized personnel approving the request.

6. The apparatus of claim 1, wherein the communications module is operable to automatically send a message to mobile devices related to the request in response to the authorized personnel approving or denying the request.

7. The apparatus of claim 1, wherein the communications module is operable to automatically communicate an updated schedule to the mobile devices in response to the work schedule changing.

8. A method comprising:
sending a work schedule to a plurality of mobile devices;
receiving a request to change the work schedule;
receiving data indicating if the request to change the work schedule is accepted;
updating the schedule via a programmed processor in response to accepting the work schedule change; and
broadcasting the updated work schedule via a communications module to the plurality of mobile devices.

9. The method of claim 8, further comprising:
verifying that a user accepting the work schedule change is authorized to accept the work schedule change before updating the work schedule.

10. The method of claim 9, further comprising:
broadcasting the request to change the work schedule to the plurality of mobile devices.

11. The method of claim 10, further comprising:
receiving data from a mobile device of the plurality of mobile devices indicating that an entity on the workforce is willing to accommodate the work schedule change.

12. The method of claim 11, further comprising:
determining if the entity willing to accommodate the work schedule change is qualified to accommodate the work schedule change.

13. The method of claim 12, further comprising:
sending a message to the entity willing to accommodate the work schedule change in response to automatically determining if the entity willing to accommodate the work schedule change is qualified to accommodate the work schedule change.

14. The method of claim 13, wherein receiving a request to change the work schedule includes receiving a request from a mobile device indicating the user of the mobile device is willing to take on more work.

15. A computer readable storage device including instructions stored thereon, the instructions, which when executed by a machine, cause the machine to perform operations comprising:
sending a work schedule to a plurality of mobile devices;
receiving a request to change the work schedule;
receiving data indicating if the request to change the work schedule is accepted;
updating the schedule via a programmed processor in response to accepting the work schedule change; and
broadcasting the updated work schedule via a communications module to the plurality of mobile devices.

16. The computer readable storage device of claim 15, wherein the instructions further comprise instructions, which when executed by the machine, cause the machine to perform operations comprising:
verifying that a user accepting the work schedule change is authorized to accept the work schedule change before updating the work schedule.

17. The computer readable storage device of claim 16, wherein the instructions further comprise instructions, which when executed by the machine, cause the machine to perform operations comprising:
broadcasting the request to change the work schedule to the plurality of mobile devices.

18. The computer readable storage device of claim 17, wherein the instructions further comprise instructions, which when executed by the machine, cause the machine to perform operations comprising:
receiving data from a mobile device of the plurality of mobile devices indicating that an entity on the workforce is willing to accommodate the work schedule change.

19. The computer readable storage device of claim 18, wherein the instructions further comprise instructions, which when executed by the machine, cause the machine to perform operations comprising:
determining if the entity willing to accommodate the work schedule change is qualified to accommodate the work schedule change.

20. The computer readable storage device of claim 19, wherein the instructions further comprise instructions, which when executed by the machine, cause the machine to perform operations comprising:
sending a message to the entity willing to accommodate the work schedule change in response to automatically determining if the entity willing to accommodate the work schedule change is qualified to accommodate the work schedule change.
